(19) United States
(12) Patent Application Publication
(10) Pub. No.: US 2025/0278996 A1
(43) Pub. Date: Sep. 4, 2025

(54) ELECTRONIC IDENTIFICATION APPARATUS

(71) Applicants: Jason Hesbol, Grafton, WI (US); Anthony C. Worthey, Pickerington, OH (US)

(72) Inventors: Jason Hesbol, Grafton, WI (US); Anthony C. Worthey, Pickerington, OH (US)

(21) Appl. No.: 19/068,408

(22) Filed: Mar. 3, 2025

Related U.S. Application Data
(60) Provisional application No. 63/560,013, filed on Mar. 1, 2024.

(51) Int. Cl. G08B 25/01; G06K 7/14; G08B 21/02; H04W 4/029; H04W 4/90

(52) U.S. Cl. CPC G08B 25/016; G06K 7/1417; G08B 21/02; H04W 4/029; H04W 4/90

(57) ABSTRACT

An electronic identification apparatus is disclosed, designed for military personnel to enhance casualty management. This device addresses the limitations of traditional dog tags by incorporating GPS tracking and comprehensive medical data storage. The apparatus comprises a casing with a removable backing and a fiducial marker, a computing system with a GPS module for real-time geolocation, and a power source. The system facilitates medical support by transmitting geolocation data and retrieving user information from a datastore upon scanning the fiducial marker. This information is then displayed on a device, aiding in rapid casualty identification and location. The apparatus is rugged, environmentally resistant, and can be worn like a traditional dog tag, providing a durable, low-cost solution for active tracking and situational awareness in combat scenarios.

### CROSS-REFERENCE TO RELATED APPLICATIONS

This application claims benefit to Provisional Application No. 63/560,013, filed Mar. 1, 2024, the contents of which are herein incorporated by reference.

### BACKGROUND OF THE INVENTION

### Field of Endeavor

The present invention relates to identification apparatuses, and more particularly, to an electronic identification apparatus with GPS tracking functionality.

### Background and Related Art

Currently, military personnel are required to wear an apparatus that contains identifying information, typically referred to as a dog tag, in case of a casualty event. Typically, dog tags are made of a durable material, such as metal, and contain a limited amount of personally identifying information, and additional metadata about the wearer.

When a casualty event occurs, the probability of a successful outcome increases with the speed of locating the casualty and with the amount of medical information provided to medical personnel about the casualty. Current dog tags are disadvantageous because they provide no mechanism by which a casualty can be located, and only provide limited medical information to medical personnel, such as blood type.

As can be seen, there is a need for an improved electronic identification apparatus adapted for active tracking and storage of more complete personnel information.

### SUMMARY OF THE INVENTION

In one embodiment, the disclosure includes an electronic identification apparatus comprising a casing with a removable backing, wherein the casing includes a fiducial marker thereon; a computing system, having a GPS module, installed within the casing configured to provide real-time geolocation data; and a power source adapted to provide power to the GPS module.

In another embodiment, the disclosure includes a system for providing medical support, comprising at least one electronic identification apparatus; transmitting, by the electronic identification apparatus, in real-time a geolocation of a user using the computing system; in response to a scan of the fiducial marker, retrieving at least one information about a user from a datastore; and outputting, to a device, the at least one information to a display.

These and other features will be more clearly understood from the following detailed description taken in conjunction with the accompanying drawings and claims.

### BRIEF DESCRIPTION OF THE DRAWINGS

FIG. 1 is a top perspective view of an embodiment of an electronic identification apparatus, according to aspects of the present invention;

FIG. 2 is a bottom perspective view an embodiment of an electronic identification apparatus, according to aspects of the present invention;

FIG. 3 is a top plan view of an embodiment of an electronic identification apparatus, according to aspects of the present invention;

FIG. 4 is a bottom plan view of an embodiment of an electronic identification apparatus, according to aspects of the present invention;

FIG. 5 is a side elevation view of an embodiment of an electronic identification apparatus, according to aspects of the present invention; and

FIG. 6 is a schematic diagram of a system for identification using an electronic identification apparatus, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Increasing the probability of a successful outcome from a combat casualty requires rapid identification and location of the casualty, along with detailed information about the casualty's personnel information, such as medical history, allergies, blood type, etc.

Broadly, an embodiment of the present invention provides an electronic identification apparatus and system adapted for active tracking of the wearer, and electronic storage of personnel information of the wearer. The electronic identification apparatus of the present invention can be a computing system protected by a rugged housing and can be configured to provide both active tracking of a wearer, and one or more situational awareness information relevant to a wearer. The rugged housing can include a plurality of indicia thereon configured to provide the one or more situational awareness information of the wearer. The system of the present invention includes the electronic identification apparatus of the present invention and one or more computing systems interconnected by one or more networks and configured to actively track a wearer of the apparatus and provide one or more situational awareness information relevant to the wearer. Advantageously, the apparatus and system of the present invention provide a low-cost, durable solution to tracking a wearer and providing situational awareness related to the wearer.

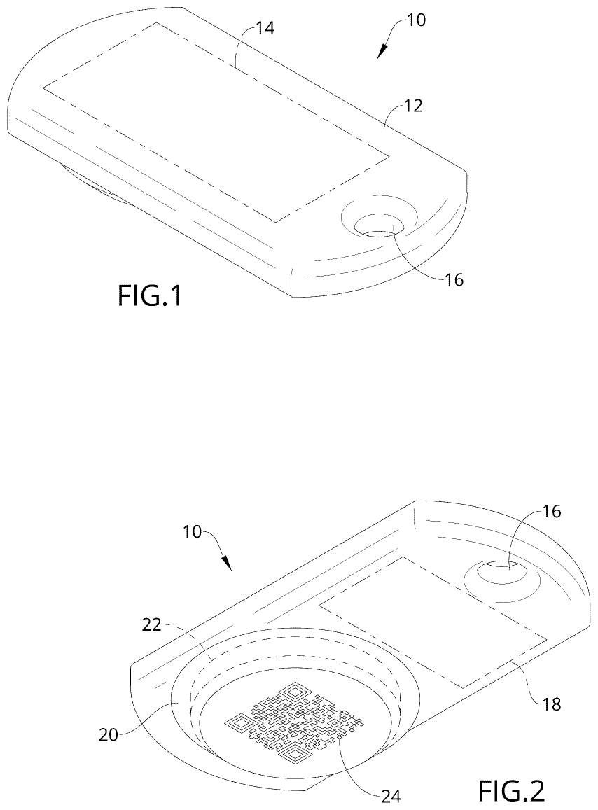

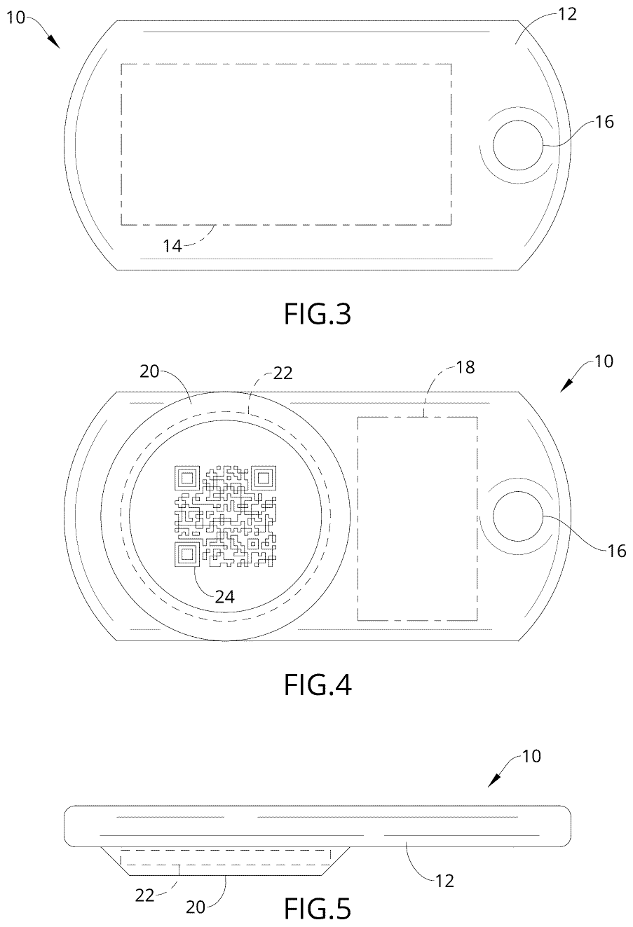

Referring now to FIGS. 1-5, an electronic identification apparatus with active tracking, herein e-DogTag 10, is illustrated. e-DogTag 10 can include a casing 12 with a one or more marking, or engravings, such as fiducial marker 24 engraved thereon. e-DogTag 100 can be a computing system, such as a microprocessor, and can include a Global Positioning System (GPS) module 22 stored in a removeable housing 20 of housing 12 with an associated power source, such as a battery. e-DogTag 10 can be worn in place of a traditional dog tag by routing a chain, or other material, through attachment mechanism 16.

Referring more specifically to physical aspects of e-DogTag 10, housing 12 can include a plurality of surfaces and can be formed from one or more materials. In an embodiment, housing 12 can have environmentally resistant qualities, such as waterproof, blast proof, ballistic proof, heat proof, etc., and can be formed, or otherwise manufactured, of material that provides protection from environmental conditions encountered in combat, such as explosions, fire, water intrusion, and/or projectile impact. Housing 12 can have a plurality of surfaces, such as a front surface and a rear surface that can be continuously connected by one or more additional surfaces. In an embodiment, the front surface of housing 12 can include an engraving area 14 configured to accept marking, engraving, impression, etc., of one or more fiducial marks specifying information about a wearer of e-DogTag 10. In an embodiment, the one or more fiducial marks can include a name, a unique identifier, an one or more medical information about the wearer. Additionally, the rear surface of housing 12 can include an engraving area 18 configured to accept marking, engraving, impression, etc., of one or more fiducial marks specifying information about a wearer of e-DogTag 10. In an embodiment, the one or more fiducial marks can include a name, a unique identifier, an one or more medical information about the wearer. An attachment mechanism 16 can be formed between the front surface and the rear surface as an aperture, or hole, disposed from the front surface to the rear surface. In an embodiment, the attachment mechanism can allow the wearer to thread a apparel item such as chain, necklace, string, clip, etc., therethrough and place the apparel item on themselves thereby securing e-DogTag 10 to the wearer.

Housing 12 can have a removable housing 20, which can be adapted to open housing 12 for installation, repair, and/or replacement of any/all components of computing system, GPS Module 22, and/or the power source. Housing 12 can include a fiducial marker 24 engraved, or otherwise printed, on a portion thereof. Fiducial marker 24 can be adapted to link to a data store contain personnel information about a user wearing e-DogTag 10. It is understood that fiducial marker can be any type of machine readable code capable of decoding to provide a user information, such as but not limited to, QR codes, barcodes, etc.

Referring now to computing system with GPS Module 22, the device and GPS module 22 can be installed inside of casing 12 utilizing removable housing 20, such that computing system with GPS module 22 can be protected from environmental conditions. GPS Module 22 can be a receiver/transmitter that is configured to triangulate to a plurality of GPS satellites, determining and generating geo-location or position data such as latitude-longitude values for a geophysical location of the e-DogTag 10 and transmitting those locations. It is understood that GPS module 22 functions as a GPS Location device as known in the art. Computing system with GPS Module 22 can include hardware, software, firmware and interfaces for generating position reporting packets, notifications, pulse or heartbeat signals, or other recurring data transmissions that specify a position of the e-DogTag 10, alone or in combination with other application-specific data.

The eDogTag 10 configuration provides several advantages over traditional identification methods. The integration of a GPS module 22 within the computing system allows for real-time geolocation data, which significantly enhances the ability to locate personnel quickly in emergency situations. This is particularly beneficial in military or first responder scenarios where rapid location tracking can be important for safety and operational efficiency. The GPS module 22, protected by the rugged housing 12, ensures that eDogTag 10 remains functional in harsh environmental conditions, such as severe weather or combat zones, thereby maintaining the reliability of the tracking system.

The fiducial marker 24 on housing 12 serves as a machine-readable code, such as a QR code, which links to a database 612 containing comprehensive personnel information. This eliminates the need for personally identifiable information to be physically printed on the device, thereby enhancing privacy and security. The removable backing of the casing allows for easy access to the internal components, facilitating maintenance and battery replacement, which extends the operational life of the apparatus.

Overall, eDogTag 10 provides a durable, low-cost solution for active tracking and situational awareness, addressing the limitations of traditional dog tags by offering enhanced functionality and security features.

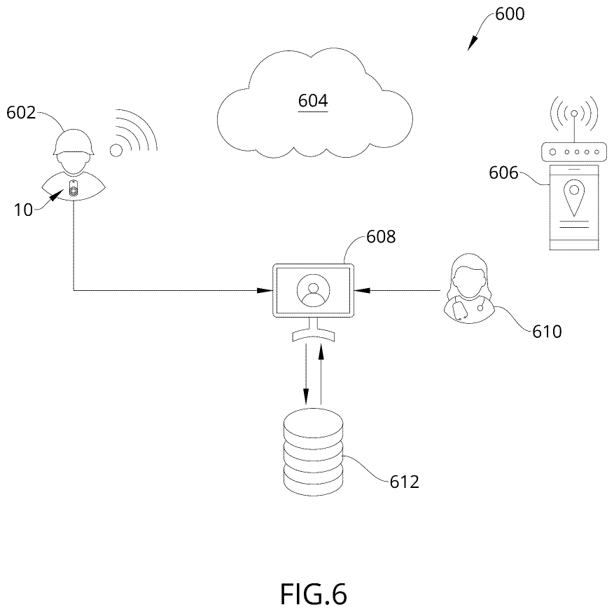

Referring now to FIG. 6, an embodiment of a system 600 for utilizing e-DogTag 10 is illustrated. Personnel 602 can be wearing, carrying, or otherwise have secured to their person, e-DogTag 10, which can be calculated and transmitting a geo-location, in real-time, through network 404 using computing system with GPS module 22. In the case of a casualty event, or other need to locate personnel 602, a device 606, such as a computing system, can receive and output a geolocation transmitted from e-DogTag 10, through one or more networks, such as network 604. Utilizing the received geolocation additional personnel may extract, or otherwise secure, personnel 602 for transport. In case of a casualty event, personnel 602 may be treated my medical personnel 610, who can extract personnel's 602 information from e-DogTag 10 by decoding fiducial marker 24 using device, such as a computing system, or scanner, 608. Device 608 can utilize information decoded from fiducial marker 24 to query database 612 to retrieve information associated with personnel 602. In an embodiment, personnel information can include comprehensive demographic information, and/or medical information. It is understood that the number and type of users, devices, and networks is exemplary in nature and not meant to be limiting, as any number of users, devices and networks is contemplated to be within the scope of the invention.

System 600 for providing medical support that utilizes an electronic identification apparatus to transmit real-time geolocation data and retrieve user information from a database upon scanning a fiducial marker 24. This system enhances the efficiency and effectiveness of medical response in emergency situations by enabling rapid location and identification of personnel. The integration of a GPS module 22 within eDogTag 10 allows for continuous tracking of the user's location, which is important in scenarios where time is of the essence, such as military operations or first responder activities.

The fiducial marker 22, which can be a QR code or similar machine-readable code, provides a secure and efficient means of accessing comprehensive personnel information without the need for physical documentation. This reduces the risk of data loss or misplacement and ensures that medical personnel have immediate access to important information, such as medical history and allergies, which can significantly impact treatment decisions.

By outputting the retrieved information to a display device, the system 600 facilitates quick and informed decision-making, thereby improving the chances of a successful medical intervention. The arrangement of components within the system, including the electronic identification apparatus, datastore, and display device, ensures seamless communication and data flow, which is crucial for maintaining operational efficiency in high-pressure environments. This system offers a practical solution to the limitations of traditional identification methods by providing a robust, real-time tracking and information retrieval mechanism.

Broadly, an embodiment of the present invention may include one or more servers and at least one computer. Each server and computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. An electronic identification apparatus, comprising:
a casing with a removable backing, wherein the casing includes a fiducial marker thereon;
a computing system, having a GPS module, installed within the casing configured to provide real-time geolocation data; and
a power source adapted to provide power to the GPS module.

2. A system for providing medical support, comprising:
at least one electronic identification apparatus of claim 1;
transmitting, by the electronic identification apparatus, in real-time a geolocation of a user using the computing system;
in response to a scan of the fiducial marker, retrieving at least one information about a user from a datastore;
outputting, to a device, the at least one information to a display.
